(19) United States
(12) Patent Application Publication
(10) Pub. No.: US 2008/0052674 A1
(43) Pub. Date: Feb. 28, 2008

(54) Code Aggregation and Sharing

(76) Inventor: Donald Edward Little, Park City, UT (US)

Correspondence Address: HOLME ROBERTS & OWEN, LLP, 299 SOUTH MAIN, SUITE 1800, SALT LAKE CITY, UT, 84111, US

(21) Appl. No.: 11/467,540

(22) Filed: Aug. 25, 2006

(51) Int. Cl. G06F 9/44

(52) U.S. Cl. 717/120

(57) ABSTRACT

Systems, methods and computer program products for collecting and storing, searching, and sharing units of software. In one embodiment at least one unit of software is received from each of a plurality of collaborators. The software code is stored in a repository and indexed such that a subsequent collaborator or other user, when searching for desired code, can identify the previously submitted code and use it. In one embodiment, each collaborator receives credits in return for submitting software units that can in turn be used to acquire code at another time. In another embodiment, the code is stored in a secure repository such that it can be used as prior art in patent infringement litigation but cannot be used by another party in commerce.

### BACKGROUND OF THE INVENTION

1. The Field of the Invention

The present invention relates to the field of software storage systems and databases. More particularly, embodiments of the present invention include the storage of units of software in such a way that they can be identified and used by members of a collaborative group.

2. The Relevant Technology

There is currently an increasing threat against companies of infringing computer software patents. Because computer software and computer software patents in particular are relatively new, however, and comprehensive databases and indexes rare and difficult to create or maintain, it can be difficult to identify prior art that would invalidate an asserted patent even where it is apparent that the computer software patent is unlikely to be valid over the prior art. There is, accordingly, a need for more effective ways of identifying prior art related to computer software patents.

### BRIEF SUMMARY OF THE INVENTION

The present invention satisfies the foregoing need by providing systems, methods and computer program products for gathering and storing, searching, and sharing code units that may become prior art to asserted patents. The present invention uses the fact that there is a growing body of software that has been developed for use by individual entities but has utility beyond that of just the use contemplated by the entity originally commissioning or performing the software development. That software code is aggregated from multiple entities that collaborate to store the software code, not only for prior art purposes, but also for use by one another according to the terms of their collaborative agreement. The code is conceptually stored in a repository similar to a bank, but instead of dollars the code bank, or repository, stores code. In one embodiment, at least one unit of software is received from a collaborator and is stored in a repository and indexed such that a subsequent collaborator or other user, when searching for desired code, can identify the previously submitted code and use it either for prior art or for their regular business operations.

Accordingly, a first example embodiment of the invention is a method of collecting and storing software code. The method generally includes: receiving at least one unit of software from a plurality of collaborators, receiving information representative of data regarding one or more of the units of software, analyzing the units of software and the information to generate one or more code values for each unit of software, storing the units of software and the code values in a repository, and providing to each collaborator one or more credit points based on the code values assigned to the units of software.

Another example embodiment of the invention is a method of identifying and sharing software code. The method generally includes: providing a code repository having a plurality of units of software, receiving a request from an entity to receive units of software related to a defined functionality, searching the code repository to identify at least one unit of software related to the functionality and at least one corresponding value associated with the unit of software, verifying the entity is eligible to receive the identified unit of software, and if the entity is eligible to receive the identified units of software, providing the entity a code utilization price related to the values.

Yet another example embodiment of the invention is a method is a method of identifying software code for use as prior art in patent infringement litigation. The method generally includes: receiving at least one unit of software from a plurality collaborators; receiving information representative of data regarding one or more of the units of software; analyzing the units of software and the information representative of data regarding one or more of the units of software to generate one or more search parameters for each unit of software, wherein the search parameters can be used to identify content and functionality of the units of software; storing the units of software and the search parameters in a prior art repository; analyzing the units of software and the information to generate one or more code values for each unit of software; and providing to each collaborator one or more credit points based on the code values assigned to the units of software each respective collaborator submitted, whereby the credit points can be used to access the prior art repository.

Yet another example embodiment of the invention is a software repository system. The system generally includes: an indexing module configured for receiving units of software and data descriptive of the units of software and generating search parameters descriptive of the content of the units of software and one or more values associated with the units of software; a shared code data storage module for receiving and storing at least one of the units of software, the search parameters, and the values; a query module configured for: receiving a search request from a user; performing a search of at least one of the units of software and the search parameters to identify any units of software responsive to the search request; and providing to the user an identification of at least one unit of software responsive to the search request and providing the user a code utilization cost that is based upon the one or more values.

These and other objects and features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a system diagram of an exemplary environment in which the present invention can be implemented according to one example embodiment of the invention; and

FIG. 2 is another system diagram of an exemplary environment in which the present invention can be implemented according to another example embodiment of the invention.

### DETAILED DESCRIPTION OF THE PREFERRED EMBODIMENTS

Reference will now be made to the drawings to describe various aspects of exemplary embodiments of the invention. It is to be understood that the drawings are diagrammatic and schematic representations of such exemplary embodiments, and are not limiting of the present invention, nor are they necessarily drawn to scale.

In the following description, numerous specific details are set forth in order to provide a thorough understanding of the present invention. It will be obvious, however, to one skilled in the art that the present invention may be practiced without these specific details. In other instances, well-known aspects of computing systems, networks, databases, and the like have not been described in particular detail in order to avoid unnecessarily obscuring the present invention.

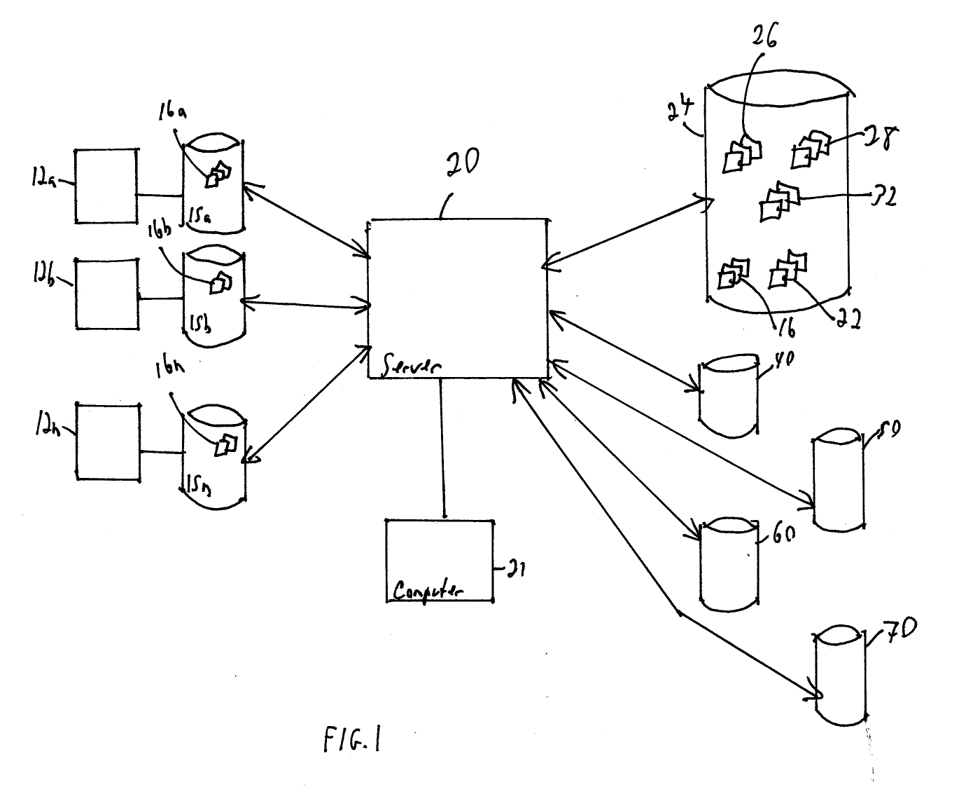

With reference now to FIG. 1, an example collaborative system 10 is shown according to an embodiment of the present invention. It will be understood that the particular systems and network in FIG. 1 are shown for illustrative purposes only and do not limit the invention. Other implementations for performing the functions described herein will be apparent to persons skilled in the relevant art(s) based on the disclosure contained herein, and the invention is directed to such other implementations. As will be apparent to one skilled in the relevant art(s), all components of the collaborative system 10 are connected and communicate via a communication medium such as the Internet, a wide area network (WAN) or a local area network (LAN). One skilled in the relevant art(s) will also appreciate that, for security reasons, any databases, systems, or components of the present invention may consist of any combination of databases or components at a single location or at multiple locations, wherein each database or system includes any of various suitable security features, such as firewalls, access codes, encryption, decryption, compression, decompression, and/or the like.

The collaborative system 10 is illustrated as a collaborative network in which a plurality of entities 12A-12N interface with a software repository management system 14 according to an embodiment of the invention. Each of the entities 12a-12n can be a separate company, individual, university, etc. that desires to interact with the repository management system 14 to contribute to and/or receive code from the repository management system 14. In a preferred embodiment of the invention, the entities 12a-12n each possess their own code libraries 15A-15N with units of software 16A-16N of value to the network 10 they can contribute. As used herein, the term “unit of software” includes within its scope computer software of any size or functionality. While it is preferred that functional programs, or segments thereof, are used, this is not necessary.

By way of example, each of the entities 12A-12N can interact with repository management system 14 through a global communications network such as the Internet, within a smaller secure network, or by exchange of data through exchange of physical data storage devices. Where data is transmitted over a global network, a firewall (not illustrated) is preferably used for secure separation between the various entities and the repository management system. A firewall is well known to those skilled in the art and serves as a is a dedicated gateway with special security precaution software to protect a device or network from an external invasion.

Units of software 16A-16N are initially received in system 14 at management server 20. While one management server 20 is shown in FIG. 1, it will be apparent to one skilled in the relevant art that system 14 may be administered by one or more computers such as workstation 21 or in a distributed fashion over a plurality of the network elements connected via a LAN. Similarly, while several databases (i.e., 24, 40, 50, 60, 70) are shown in FIG. 1, it will be apparent to one skilled in the relevant art(s) that system 14 may utilize databases physically located on server 20 or one or more additional computers.

Server 20 processes the software units it receives from the entities 12 or another source to generate one or more of relevant search terms, code values, risk assessments, and the like that can be used to identify and effectively distribute the code in the future. The code and related information is stored in a collaborative database 24, prior art database 50, and/or secure database 70. As used herein, the term “database” or similar terms may refer to any type of data organizing mechanism, such as relational databases, hierarchical databases, object-oriented databases, spreadsheets, and/or the like. Common database products that may be used to implement the databases are well known in the art and can be obtained from companies such as the Oracle Corporation (Redwood Shores, Calif.), and Microsoft Corporation (Redmond, Wash.), or any other database product.

Databases may be organized in any suitable manner, including as data tables or lookup tables. Association of certain data may be accomplished through any data association technique known and practiced in the art. For example, the association may be accomplished either manually or automatically. Automatic association techniques may include, for example, a database search, a database merge, GREP, AGREP, SQL, and/or the like. It should also be understood that a system of the present invention is not limited to a physical implementation of a single repository of information. It is also possible to have multiple repositories of information. The multiple repositories may be linked together in a variety of different manners to create a single logical repository of information.

Units of software 16 that are received from a collaborator 12 are stored in database 24 unless they are designated as trade secrets or are otherwise confidential, in which case they can be stored in secure database 70. Software stored in database 70 can be accesses for prior art searching. Software stored in database 70 may also be made available only to certain entities that are approved to review and use it for whatever reason. Units of software 22 that have been submitted at other times may be accessed and used by one or more additional collaborators according to terms of agreements. In a preferred embodiments of the invention, the collaborators have a joint venture that owns all IP rights and collaborators or customers can access the stored software for a fee and/or for credits earned by participation in the joint venture.

Preferably, code that has been received from the repository system 14 by a collarborator and then improved upon remains the property of the joint venture for future use by the joint venture. Such improved code, as well as code developed for the joint venture under commission by a third party, can be stored in a derivative database 40. Similarly, an index to third party code or software in the public domain can be stored at database 60.

Values can be assigned to code units by computer means to receive, store and evaluate software, example of computer means include code indexing module 80, query module 82, IP module 83, and derivative tracking module 84. The code indexing module 80 is a module or computer program product that receives the code or information 26 related to the code and generates search parameters descriptive of the content of the units of software and one or more values associated with the units of software. Code indexing module 80 can operate to receive subjective scoring information from a user or can run an automated program to derive values. The code indexing module 80 can be used not only to set values such as purchase or acquisition prices for the unit of software but also to generate credit points for contributors, generate risk scores for using certain code, and for dynamically updating these and other values over time. Useful metrics, equations, and valuation systems are known to those skilled in the art and their selection and application will be apparent in view of the disclosure here. In such an embodiment, code indexing module 80 can be commercially supplied (e.g., in an off-the-shelf or ASP-type manner) by various companies that focus on such technologies.

The primary code storing database 24 will include various types of information, including units of software 16, 22, information 26 about the units of software, IP database 28 which includes all known issued IP rights protecting to the collaborative code, a value index 32, and the like.

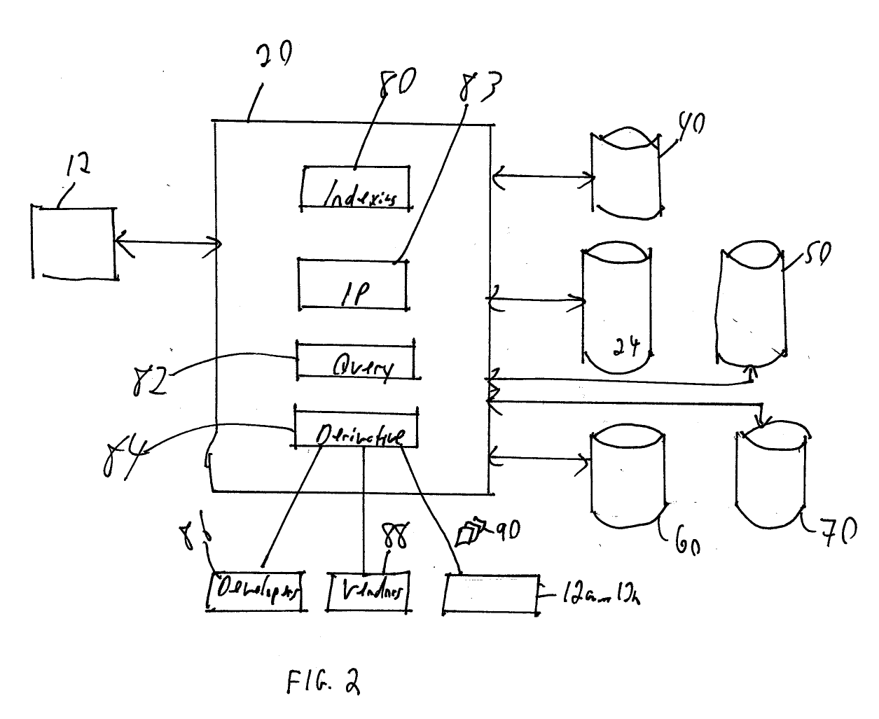

With reference to FIGS. 1 and 2, the IP database 28 can be managed and updated by IP tracking module 83. The IP database 28 preferably also includes all known issued IP rights related to the collaborative code. The IP database preferably also includes all known IP rights related to any third party code or collaborative code, whether or not it is owned by the collaborative network or any if its members. For example, in an embodiment where the intellectual property includes patent rights, the database can be populated from (or be a duplicate of) the publicly available issued patent databases available from the public patent offices such as the U.S. Patent and Trademark Office, the European Patent Office, and the Japanese Patent Office. In one embodiment, such data would be arranged and searchable by internationally-recognized (e.g., WIPO “kind codes” or the like) fields such as one or more of the following: Patent Number, Inventor Name, Issue Date, Inventor City, Title, Inventor State, Abstract, Inventor Country, claim, Attorney, Agent, Specification, Assignee Name, Classification, Assignee City, Assignee State, Application Number, Assignee Country, Application Date, Examiner, Priority Information, References, Maintenance Fee Status, Annuity Fee Status or Application Type.

As will be appreciated by those skilled in the relevant art(s) after reading the description herein, IP database 28, in an embodiment, may contain historical data for one or more types of issued IP rights (e.g., patent, trademark, service mark, copyright, etc.) rights accumulated from (i.e., mirroring) the various IP rights offices throughout the world and have the associated fields customarily kept for such IP right types. In an alternate embodiment, IP tracking module 83 may have manually or automated input data or may operate a crawler, script, applet, bot, robot or any other computer program product which can “scrape” such information in a batch, real-time or just-in-time fashion from the publicly-available data from the USPTO, EPO, JPO and/or the like.

As used herein, “intellectual property” rights refers to rights under patent, trademark, copyright and trade secret laws, and any other intellectual property, industrial property or proprietary rights recognized in any country or jurisdiction worldwide, including, without limitation, moral rights and similar rights. “Intellectual property right” is differentiated from, and should not be read to mean, the underlying process, machine, manufacture, or composition of matter, etc., protected by the intellectual property (legal) right.

Query module 82 can be used to receive search requests from a collaborator 12 or customer, search the databases, 24, 40, 50, 60, 70 and return relevant search results along with a utilization price to which credits can be applied. The query module is configured for receiving a search request from a user; performing a search of at least one of the units of software and the search parameters to identify any units of software responsive to the search request; and providing to the user an identification of at least one unit of software responsive to the search request and providing the user a code utilization cost that is based upon the one or more values.

The query module 82 operates in an example method of the invention by searching the code repository to identify at least one unit of software related to the functionality and values associated with the unit of software; verifying the entity is eligible to receive the identified unit of software; and if the entity is eligible to receive the identified units of software, providing the entity a code utilization price related to the values. The desired functionality can be for use as prior art related to an invalidity or noninfringement defense in a patent infringement litigation.

The query module 82 can, upon receiving payment of the code utilization price from the entity, provide the units of software to the entity under an agreement that any improvements to the code by the entity are subject to rights held by a collaborative group that has rights in the identified units of software. The entity can, for example, be a customer or a party that has previously submitted units of software to the code repository, received one or more credit points for contributing the submitted units of software, and applies at least one of the credit points to the code utilization price to acquire the units of software.

The query module can also, upon identifying the contributor of the identified units of software, adjust the credit points awarded the contributor to reflect that the contributed units of software were identified in a search and provided to an entity.

In a preferred embodiment, providing an entity the code is subject to the condition that the code not by utilized in a market segment designated by the party that originally contributed the code to a collaborative group that has rights in the identified units of software.

The query module 82 can also be used to search prior art database 50 or other sources for software code or other prior art for use as prior art in patent infringement litigation. The method can include: receiving at least one unit of software from one or more collaborators; receiving information representative of data regarding one or more of the units of software; analyzing the units of software and the information representative of data regarding one or more of the units of software to generate one or more search parameters for each unit of software, wherein the search parameters can be used to identify content and functionality of the units of software; storing the units of software and the search parameters in a prior art repository; analyzing the units of software and the information to generate one or more code values for each unit of software; and providing to each collaborator one or more credit points based on the code values assigned to the units of software each respective collaborator submitted, whereby the credit points can be used to access the prior art repository. Such are can also be acquired from a national or multinational patent office or from a party that is not a collaborator but otherwise submits art.

Derivative engine 84 can be used, in response to an incompletely satisfied query, to seek additional code from collaborators, custom developers and vendors. The derivative engine 84 can also be used to track improvements to collaboratively owned code that has given to a user under condition that improves are the property of the collaborative group, or if other rights have been assigned.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

Although not required, the invention is generally described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those skilled in the art will appreciate that the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed or networked computing environment, program modules may be located in both local and remote memory storage devices. As such, program modules and “engines” can be spread across multiple devices and locations and various processes in each can be spread among various devices and locations across the network.

The computer may operate in a networked environment using logical connections to one or more remote computers. The remote computers and may each be another personal computer, a server, a router, a network PC, a peer device or other common network node, and typically include many or all of the elements described above relative to the computer. The logical connections, by way of example and not limitation, may include a local area network (LAN) and a wide area network (WAN) or a global communications network such as the Internet. Such networking environments are commonplace in office-wide or enterprise-wide computer networks, intranets and the Internet.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for collecting and storing units of software, the method comprising:
providing computer means operable to receive, store, and evaluate software;
receiving at least one unit of software to the computer means from each of a plurality of collaborators;
receiving information representative of data regarding at least one of the units of software;
operating the computer means to evaluate each of the one unit of software to ascertain at least one preselected characteristic of the one unit of software and to generate one or more code values reflective of the preselected characteristic for each unit of software;
storing each unit of software; and
operating the computer to create an account for each of the plurality of users and to place in each of the accounts the code value for each unit of software supplied by a respective collaborator.

2. The method of claim 1, wherein the computer includes output means for transmitting units of software to a collaborator and wherein a collaborator is in communication with the output means to receive a selected unit of software from the computer, the computer means being operable to thereupon subtract the code value reflective of the preselected characteristic from the account of the collaborator.

3. The method of claim 1, further comprising dynamically receiving additional information representative of data regarding one or more of the units of software and adjusting at least one of the code values to reflect the newly received information.

4. The method of claim 1, further comprising storing the information representative of data regarding the unit of software in the repository.

5. The method of claim 1, further comprising the act of collecting further information representative of data regarding one or more of the units of software from a source other than the collaborator that submitted the code.

6. The method of claim 1, wherein the source other than the collaborator comprises at least one of the U.S. Patent and Trademark Office and U.S. court records.

7. The method of claim 1, wherein the act of collecting information representative of data regarding one or more of the units of software comprises collecting information selected from the group consisting of: code language, code functionality, code related intellectual property, code related licenses, a list of other users of the code, a list of any requested restrictions on the collaborative use of the code, length of use of the code, the code developers, and known competitors.

8. The method of claim 1, further comprising the act of analyzing the information representative of data regarding one or more of the units of software and generating a risk factor score descriptive of the intellectual property risk associated with operating the unit of software.

9. The method of claim 1, further comprising the act, upon identifying an accusation of patent infringement against at least one collaborator, of searching the repository to identify prior art suitable for use in a defense against the accusation of patent infringement.

10. A computer program product having computer-executable instructions for performing the method of claim 1.

11. A method of providing software code, the method comprising:
providing a code repository having a plurality of units of software;
receiving a request from an entity to receive units of software related to a defined functionality;
searching the code repository to identify at least one unit of software related to the functionality and identify a value associated with each identified unit of software;
verifying the entity is eligible to receive the identified unit of software; and
if the entity is eligible to receive the identified units of software, providing the entity a code utilization price related to the values.

12. The method of claim 11, wherein the defined functionality is for use as prior art related to an invalidity or noninfringement defense in a patent infringement dispute.

13. The method of claim 11, further comprising, upon receiving payment of the code utilization price from the entity, providing the units of software to the entity under an agreement that any improvements to the code by the entity are subject to rights held by a collaborative group that has rights in the identified units of software.

14. The method of claim 11, wherein the entity has previously submitted units of software to the code repository and received one or more credit points for contributing the submitted units of software, the method comprising the entity applying at least one of the credit points to the code utilization price to acquire the units of software.

15. The method of claim 14, further comprising the act of identifying the contributor of the identified units of software and adjusting the credit points awarded the contributor to reflect that the contributed units of software were identified in a search and provided to an entity.

16. The method of claim 11, wherein the identified units of software do not completely meet the defined functionality, the method further comprising the act of requesting code development from a third party, wherein any code developed by the third party will be owned by a collaborative group that has rights in the identified units of software.

17. The method of claim 11, wherein the act of providing the entity a code utilization price related to the values is subject to the condition that the code not by utilized in a market segment designated by a party that contributed the code to a collaborative group that has rights in the identified units of software.

18. The method of claim 11, further comprising the act of generating and providing to the entity a risk factor score related to the identified units of software that is descriptive of a risk of intellectual property infringement associated with the units of software.

19. A computer program product having computer-executable instructions for performing the method of claim 11.

20. A method of identifying software code for use as prior art in patent infringement dispute, the method comprising:
receiving at least one unit of software from a plurality of collaborators;
receiving information representative of data regarding one or more of the units of software;
analyzing the units of software and the information representative of data regarding one or more of the units of software to generate one or more search parameters for each unit of software, wherein the search parameters can be used to identify content and functionality of the units of software;
storing the units of software and the search parameters in a prior art repository;
analyzing the units of software and the information representative of data regarding one or more of the units of software to generate one or more code values for each unit of software; and
providing to each collaborator one or more credit points based on the code values assigned to the units of software each respective collaborator submitted, whereby the credit points can be used to access the prior art repository.

21. The method of claim 20, further comprising the act of receiving information regarding technology from a national or multinational patent office and storing the information regarding technology in the prior art repository.

22. The method of claim 20, further comprising the act of receiving at least one unit of software or information descriptive of at least one unit of software from a party that is not a collaborator and storing the at least one unit of software or information descriptive of at least one unit of software in the prior art repository.

23. The method of claim 20, further comprising the act of analyzing the information representative of data regarding one or more of the units of software and generating a risk factor score descriptive of the intellectual property risk associated with the units of software.

24. A computer program product having computer-executable instructions for performing the method of claim 20.

25. A software repository management system comprising:
an indexing module operable to receive units of software information representative of data regarding the units of software and generate:
search parameters descriptive of the content of the units of software; and
one or more code values associated with the units of software;
a shared code storage module for receiving and storing at least one of the units of software, the search parameters, and the values; and
a query module configured for:
receiving a search request from a user;
performing a search of at least one of the units of software and the search parameters to identify any units of software responsive to the search request; and
providing to the user an identification of at least one unit of software responsive to the search request and providing the user a code utilization cost that is based upon the one or more values.

26. A system as defined in claim 25, further comprising a data storage module having at least one repository selected from the group consisting of:
an index of prior art for use in patent litigation defense; and
an index of code not owned by an entity having rights in units of software stored in the shared code data storage module.

27. A system as defined in claim 25, further comprising a secure data storage module having one or more units of software that are designated such that they can not be provided to a user in response to a user search request.
